(19) United States
(12) Patent Application Publication
(10) Pub. No.: US 2024/0231288 A9
(43) Pub. Date: Jul. 11, 2024

(54) TRANSFORMER-ARCHITECTURE-BASED METHOD AND SYSTEM FOR IOT FOR AND SMART CONTROL OF URBAN INTEGRATED ENERGY

(71) Applicant: STATE GRID JIANGSU ELECTRIC POWER CO., LTD NANJING POWER SUPPLY COMPANY, Jiangsu (CN)

(72) Inventors: Honghua XU, Jiangsu (CN); Weiya ZHANG, Jiangsu (CN); dongxu ZHOU, Jiangsu (CN); Zhengyi ZHU, Jiangsu (CN); Xing LUO, Jiangsu (CN); Hui WU, Jiangsu (CN); Long LIANG, Jiangsu (CN); Jinjie MA, Jiangsu (CN); Hengjun ZHOU, Jiangsu (CN)

(73) Assignee: STATE GRID JIANGSU ELECTRIC POWER CO., LTD NANJING POWER SUPPLY COMPANY, Jiangsu (CN)

(21) Appl. No.: 18/074,509

(22) Filed: Dec. 4, 2022

(30) Foreign Application Priority Data
Oct. 20, 2022 (CN) 202211287681.5

(51) Int. Cl. G05B 13/02; H04L 67/12

(52) U.S. Cl. CPC G05B 13/027; H04L 67/12; G16Y 10/35

(57) ABSTRACT

According to a transformer-architecture-based method and system for IoT for and smart control of urban integrated energy, urban integrated energy IoT information acquired by a terminal from different areas is output to a server after being standardized into a sequence signal, where energy demand prediction is performed through learning of a deep learning network configured on the server, a smart control network is configured and built by using the deep learning network, real-time prediction processing is performed on the urban integrated energy IoT information acquired in real time, and a result is uploaded to a workstation for reviewing. Based on the transformer architecture, the deep learning network is combined with a fast Fourier transform algorithm and inverse transform on a sequence, and an FFT-Attention mechanism is proposed. Compared with a conventional transformer architecture, frequency domain information of a sequence is given more emphasis.

### CROSS-REFERENCE TO RELATED APPLICATION

This application claims the priority benefit of China application serial no. 202211287681.5, filed on Oct. 20, 2022. The entirety of the above-mentioned patent application is hereby incorporated by reference herein and made a part of this specification.

### BACKGROUND

### Technical Field

The present disclosure relates to the technical field of computer artificial intelligence, relates to comprehensive processing of urban energy data, and provides a transformer-architecture-based method and system for IoT for and smart control of urban integrated energy.

### Description of Related Art

The deep learning technology is a data processing technology with a process in which a huge amount of original data is mined for underlying and valuable information. It can be learned from the definition that original data must be real, objective, and noisy, while information and knowledge finally obtained should be what users can be interested in, is acceptable, and is understandable for them and should further be useful in real life. After the decomposition of acquired and processed data into diversified data sets, an effective analysis tool or algorithm is selected to perform in-depth mining and analysis, providing users with underlying valuable information and knowledge.

The deep learning technology has been applied to various areas of industrial production, especially the data processing field, for example, urban integrated energy data processing. In conventional technologies, various types of data are acquired and uploaded to a workstation for unified processing, but in one hand, there are too many types of data format, which means too much workload for a server as well as high difficulty of system maintenance and cannot ensure desirable processing speed. In the other hand, for common energy prediction scenarios in energy management, in most existing energy prediction solutions, acquired numeric data, for example, energy output data and load data, is used for predicting energy demand, while urban integrated energy data includes not only textual data such as numeric data, but an energy event usually further includes other types of data, like picture or video. As a result, existing energy management systems cannot satisfy the needs to analyze and predict a plurality of types of data.

### SUMMARY

The problem to be solved in the present invention is that a quick and efficient data processing system is needed to satisfy a requirement on urban integrated energy data management and to facilitate control of urban integrated energy and energy prediction using a plurality of types of data.

The technical solution of the present invention is a transformer-architecture-based method for IoT for and smart control of urban integrated energy, where urban integrated energy IoT information acquired by a terminal from different areas is output to a server after being standardized into a sequence signal, the IoT information includes a processed text and audio data, energy prediction is performed through learning of a deep learning network configured on the server, a smart control network is configured and built by using the deep learning network after learning, real-time prediction processing is performed on the urban integrated energy IoT information acquired in real time, a result is uploaded to a workstation for reviewing, and how a staff member handles the data result is backed up on the server; and
the deep learning network is based on a transformer architecture, and high-frequency and low-frequency decomposition is first performed on the input sequence signal through multi-level discrete wavelet decomposition (MDWD), where a high-frequency signal is used as a detail signal, a low-frequency signal is used as an approximate signal, and an encoder and a decoder in the transformer are two separate branches, where one branch utilizes a multi-head attention (MHA) module attention mechanism, the other branch utilizes a fast Fourier transform (FFT)-Attention mechanism, the detail signal uses the branch utilizing the fast Fourier transform (FFT)-Attention mechanism, where a periodicity feature is analyzed through FFT, and after processing using the attention mechanism, a key (K) and a value (V) are input to the decoder via a multilayer perceptron (MLP) module, while the approximate signal uses the other branch, where a structure is the same, but every attention module is an MHA, after outputs from the two branches are added up and go through a linear transformation, energy prediction is implemented; where FFT is performed on a query (Q), a K, and a V of an input sequence in the FFT-Attention mechanism, and then the attention module provides an output.

The present invention further provides a system for IoT for and smart control of urban integrated energy, where the system includes a service layer, an information layer, and a physical layer, where a terminal is configured in the physical layer to acquire urban integrated energy IoT information from different areas, the foregoing deep learning network is configured in the information layer and is operated to implement the foregoing control method for data analysis and prediction, a service server records a processing status of the smart control system in different scenarios, and a cloud service platform is configured to review data recorded in the service server for data management.

Deep learning is utilized in the present invention to combine architecture technologies of IoT for and smart control of urban integrated energy to implement prediction of an energy-related event and prediction of a numerical value, thereby implementing unified IoT modeling of diversified urban integrated energy as well as safe and trusted interoperation of urban integrated energy. In this way, interconnection of urban integrated energy data as information is achieved to facilitate urban economy and optimization of an industrial energy use structure.

The present invention has the following beneficial technical effects:
(1) In the present invention, acquired energy IoT information is standardized into a sequence signal that is then output to a server for learning, and whether a standardization result is in compliance with a requirement is verified. This facilitates trusted interoperation of different terminals and subsequent data analysis.
(2) A designed deep learning network can process textual and audio data, so that calculation is faster and more effective.

The system of the present invention mainly includes a service layer, an information layer, and a physical layer. Deep learning is mainly fused in the information layer, and the physical layer feeds back data information that is fused and analyzed in the information layer through deep learning. While a requirement on different scenarios is satisfied, a risk in architecture control is effectively reduced, thereby ensuring an overall sound operation of an architecture.

The FFT-Attention-based transformer architecture implements fusion of FFT and a transformer, so that the transformer can take advantage of FFT to extract a periodicity component in energy information to ensure adequate utilization of the energy information and an accurate prediction of a result. Meanwhile, an original MHA module branch is retained, to adapt to prediction of a trend. Finally, two branches are added to implement prediction of the energy information.
(3) A processing result can be uploaded conveniently, and a control architecture is efficient.

The information layer uploads a deep learning processing result to the service layer, where the service layer includes a server and a cloud service platform, the server records a processing status of a smart control architecture in different scenarios and outputs a table of optimized control, and the table of optimized control in the server can be reviewed on the cloud platform, thereby facilitating review and management.
(4) In the present invention, data for learning and prediction is backed up, and typical scenarios of various types of energy application can be obtained, thereby facilitating post analysis and application of urban integrated energy control and sharing among a plurality of engaging subjects.

### BRIEF DESCRIPTION OF THE DRAWINGS

FIG. 1 is a schematic diagram of a system for IoT for and smart control of urban integrated energy according to the present invention.

FIG. 2 is a schematic diagram of an FFT-Attention-based transformer architecture according to the present invention.

FIG. 3 is a schematic diagram of an FFT-Attention module based on FFT according to the present invention.

FIG. 4 is a schematic diagram of a structure based on multi-level discrete wavelet decomposition (MDWD) according to the present invention.

### DESCRIPTION OF THE EMBODIMENTS

In the present invention, collaboration of a terminal, a server, a deep learning network, and a workstation, is utilized to achieve a unified and standardized model for urban integrated energy IoT information, output an output of the terminal after standardization that is then input to an FFT-Attention transformer architecture for learning based on acquired data, such that energy data can be obtained for prediction. The server verifies whether the standardization is in compliance with a requirement, such that trusted interoperation between different terminals is implemented. In the present invention, data is processed through deep learning, where a large amount of data is analyzed to dig up valuable information that is then used in data management, to build a reliable and effective smart control network and process data in real time, such that only a result is required to be uploaded to the workstation for review by a staff member, while a manner of handling is backed up on the server. In this way, the same or a similar problem appeared next time can be quickly solved. As there will be an increasingly larger amount of data, there will be more and more manners of handling, and there will be more and more solutions for handling anomalous data.

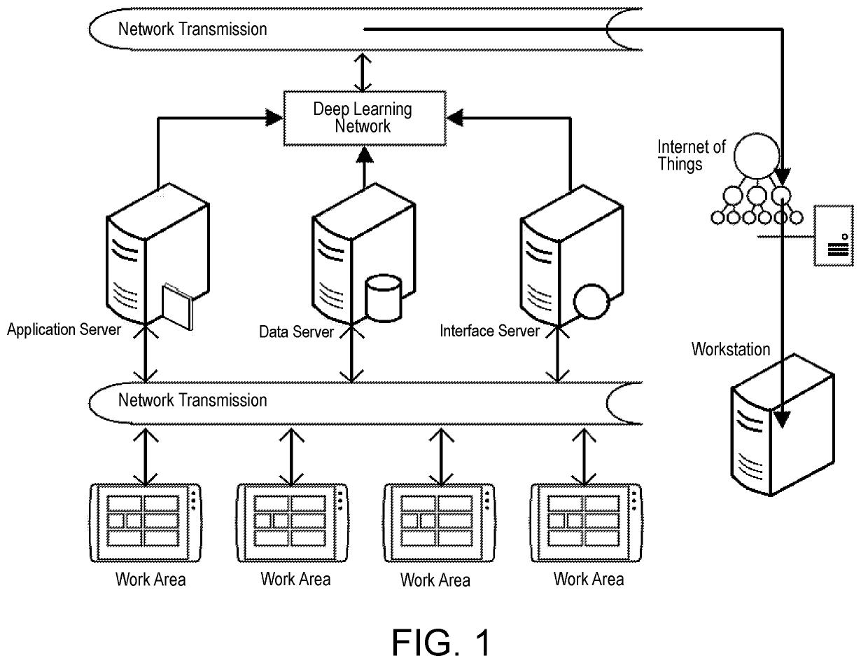

As shown in FIG. 1, in the present invention, according to a transformer-architecture-based method for IoT for and smart control of urban integrated energy, urban integrated energy IoT information acquired by a terminal from different areas is output to a server after being standardized into a sequence signal, where the IoT information includes a processed text and audio data, energy prediction is performed through learning of a deep learning network configured on the server, a smart control network is configured and built by using the deep learning network after learning, real-time prediction processing is performed on the urban integrated energy IoT information data acquired in real time, a result is uploaded to a workstation for reviewing, and how a staff member handles the data result is backed up on the server.

For data fed back from a terminal system, the application, logical, and physical design of the control architecture is based on deep learning in a manner of data sharing, thereby implementing effective energy allocation and management, helping build an energy operation and management system, managing edge-end user exits and data interfaces, designing a system architecture and functions of a cloud platform, and forming an information-based expression of resources, connections, and control of urban integrated energy.

Based on the transformer architecture, with the encoder-decoder architecture of a transformer, the deep learning network is combined with a fast Fourier transform (FFT) algorithm and inverse fast Fourier transform on a sequence, and an FFT-Attention mechanism is proposed. Compared with a conventional transformer architecture, frequency domain information of a sequence is given more emphasis. As energy data acquired by a terminal has a specific trend and periodicity feature, to take adequate use of the trend and periodicity features, a transformer architecture based on multi-level discrete wavelet decomposition (MDWD) and discrete Fourier transform are proposed in the present invention.

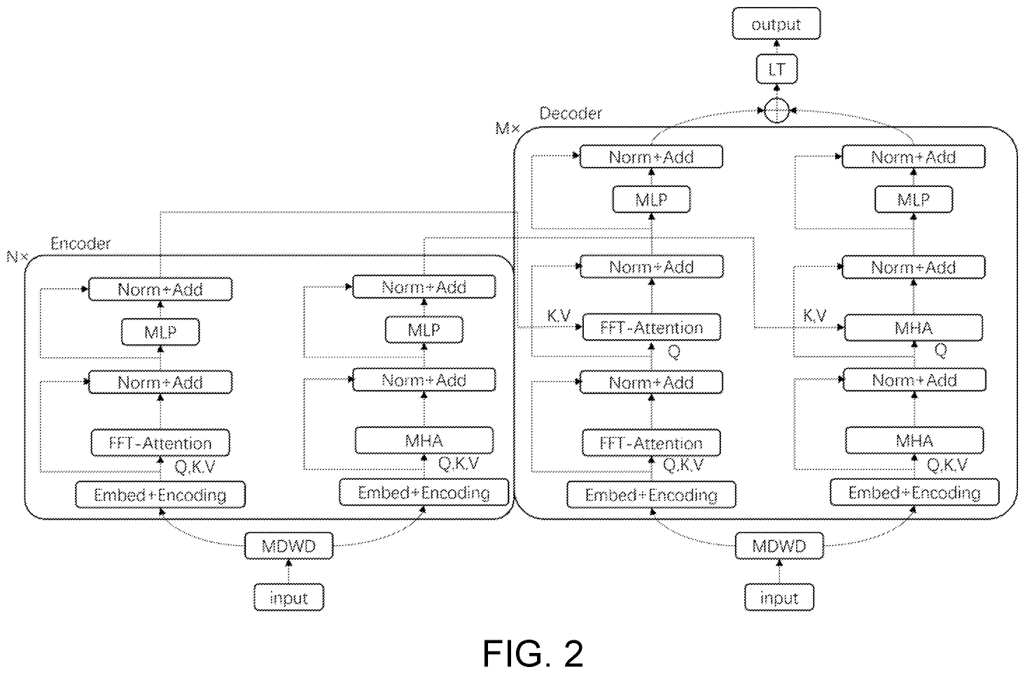

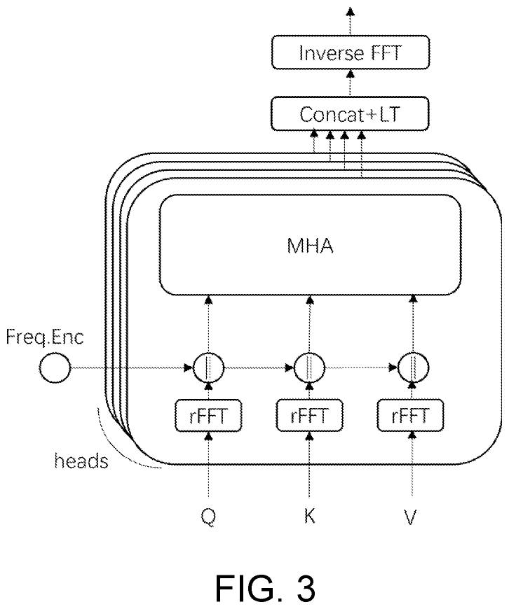

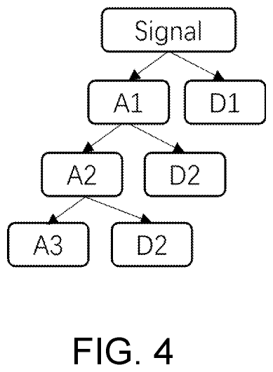

As shown in FIG. 2, high-frequency and low-frequency decomposition is first performed on the input sequence signal through multi-level discrete wavelet decomposition (MDWD). A high-frequency signal is used as a detail signal, and a low-frequency signal is used as an approximate signal. In a multilayer structure, an approximate component from one layer is used as an input fed to a next layer to generate a plurality of detail signals and one approximate signal as a final output. After FFT, different frequency features are shown, where a detail signal has a periodicity, and an approximate signal has a trend. Because of the different frequency features, the signals need to be input to different attention mechanisms for learning. In the present invention, an encoder and a decoder in the transformer are two separate branches, where one branch utilizes an FFT-Attention mechanism, the other branch utilizes an original attention mechanism of the transformer, the detail signal uses the branch utilizing the FFT-Attention mechanism to implement encoder-decoder, where a periodicity feature is analyzed through FFT, and the approximate signal uses the other branch to implement encoder-decoder. After outputs from the two branches are added up and go through a linear transformation, energy prediction is implemented, where FFT is performed on a query (Q), a key (K), and a value (V) of an input sequence in the FFT-Attention mechanism. A real number component and an imaginary number component that are output after FFT are connected to a frequency domain value, to provide information about frequency domain corresponding to a specific positional value, as the design ideas in positional encoding. The FFT output is further processed by a multi-head attention (MHA) module to implement an FFT-Attention mechanism. Any attention mechanism, for example, the ProbSparse or convolutional attention mechanism, may be used to replace the MHA module herein. FFT-Attention is as shown in FIG. 3. An output from the FFT-Attention module is connected and mapped in the transformer structure, where like various types of original attention mechanisms in a transformer, inverse FFT is performed to return a value to time domain. Multi-level discrete wavelet decomposition (MDWD) is a conventional technology whose model structure is as shown in FIG. 4.

Further, a verification rule is configured in the server to verify whether a standardization result is in compliance with a requirement, to implement trusted interoperation of different terminals, and then data is processed through deep learning.

The present invention further provides a transformer-architecture-based system for IoT for and smart control of urban integrated energy, where the service, information, and physical design of the control architecture is based on data fed back from a terminal system by using a manner of data sharing. The control system includes a service layer, an information layer, and a physical layer. A terminal is configured in the physical layer to acquire urban integrated energy IoT information from different areas, where an operational status and information of the system is acquired mainly by a terminal acquisition device, for example, a sensor, to implement real-time acquisition and unified processing of information for a device and equipment. The foregoing deep learning network is configured in the information layer and is operated to implement the foregoing control method for data analysis and prediction. The service layer includes a service server and a cloud service platform. The service server records a processing status of the smart control system in different scenarios, and the cloud service platform is configured to review data recorded in the service server for data management. By using the system of the present invention, existing data can be analyzed for prediction and includes, but is not limited to, speech and word information. A probability of an energy-related event that may happen in the future, for example, an increase or drop of a future energy price, or an increase and decrease of a required amount, is predicted, to facilitate sound allocation of energy and achieve timely and real-time data transmission.

What is claimed is:

1. A transformer-architecture-based method for Internet of Things (IoT) for and smart control of urban integrated energy, wherein urban integrated energy IoT information acquired by a terminal from different areas is an output to a server after being standardized into a sequence signal, wherein an IoT information comprises a processed text and audio data, an energy prediction is performed through learning of a deep learning network configured on the server, a smart control network is configured and built by using the deep learning network after learning, a real-time prediction processing is performed on the urban integrated energy IoT information acquired in real time, a result is uploaded to a workstation for reviewing, and how a staff member handles a data result is backed up on the server; and
the deep learning network is based on a transformer architecture, and a high-frequency and low-frequency decomposition is first performed on an input sequence signal through a multi-level discrete wavelet decomposition (MDWD), wherein a high-frequency signal is used as a detail signal, a low-frequency signal is used as an approximate signal, and an encoder and a decoder in a transformer are two separate branches, wherein one branch utilizes a multi-head attention (MHA) module attention mechanism, the other branch utilizes a fast Fourier transform (FFT)-Attention mechanism, the detail signal uses the branch utilizing the fast Fourier transform (FFT)-Attention mechanism, wherein a periodicity feature is analyzed through a FFT, and after processing using an attention mechanism, a key (K) and a value (V) are input to the decoder via a multilayer perceptron (MLP) module, while the approximate signal uses the other branch, wherein a structure is the same, but every attention module is an MHA, after outputs from the two branches are added up and go through a linear transformation, the energy prediction is implemented; wherein FFT is performed on a query (Q), a K, and a V of an input sequence in the FFT-Attention mechanism, and then the attention module provides the output.

2. The transformer-architecture-based method for the IoT for and smart control of the urban integrated energy according to claim 1, wherein a verification rule is configured in the server to verify whether a standardization result is in compliance with a requirement, to implement trusted interoperation of different terminals, and then data is processed through a deep learning.

3. The transformer-architecture-based method for the IoT for and the smart control of the urban integrated energy according to claim 1, wherein the attention module in the FFT-Attention is a multi-head attention (MHA) module for implementing attention processing.

4. A transformer-architecture-based system for the IoT for and the smart control of the urban integrated energy, comprising a service layer, an information layer, and a physical layer, wherein the terminal is configured in the physical layer to acquire the urban integrated energy IoT information from the different areas, the deep learning network according to claim 1 is configured in the information layer and is operated to implement the control method according to claim 1 for data analysis and prediction, a service server records a processing status of a smart control system in different scenarios, and a cloud service platform is configured to review data recorded in the service server for data management.
